(19) United States
(12) Patent Application Publication
(10) Pub. No.: US 2026/0058788 A1
(43) Pub. Date: Feb. 26, 2026

(54) RANDOM ACCESS CHANNEL PROCEDURES IN SUBBAND FULL DUPLEX NETWORKS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US)

(21) Appl. No.: 18/812,582

(22) Filed: Aug. 22, 2024

(51) Int. Cl. H04L 5/16; H04L 5/00; H04W 74/0833; H04W 88/06

(52) U.S. Cl. CPC H04L 5/16; H04L 5/0053; H04W 74/0833; H04W 88/06

(57) ABSTRACT

Certain aspects of the present disclosure provide techniques for preamble and physical uplink shared channel (PUSCH) transmission for random access channel (RACH) procedures in subband full duplex (SBFD) networks. An example method, performed at a user equipment (UE), generally includes receiving configuration information indicating one or more slots including subband full duplex (SBFD) slots and half duplex (HD) slots, transmitting, in a first slot, a random access channel (RACH) preamble associated with a RACH procedure, determining, based on at least one rule, at least one second slot from the one or more slots to use for at least one subsequent transmission associated with the RACH procedure, and transmitting the at least one subsequent transmission in the at least one second slot in accordance with the at least one rule.

### FIELD OF THE DISCLOSURE

Aspects of the present disclosure relate to wireless communications, and more particularly, to techniques for preamble and physical uplink shared channel (PUSCH) transmission for random access channel (RACH) procedures in subband full duplex (SBFD) networks.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a user equipment (UE). The method includes receiving configuration information indicating one or more slots including subband full duplex (SBFD) slots and half duplex (HD) slots; transmitting, in a first slot, a random access channel (RACH) preamble associated with a RACH procedure; determining, based on at least one rule, at least one second slot from the one or more slots to use for at least one subsequent transmission associated with the RACH procedure; and transmitting the at least one subsequent transmission in the at least one second slot in accordance with the at least one rule.

Another aspect provides a method for wireless communication at a network entity. The method includes transmitting configuration information indicating one or more slots including subband full duplex (SBFD) slots and half duplex (HD) slots; receiving, in a first slot, a random access channel (RACH) preamble associated with a RACH procedure; determining, based on at least one rule, at least one second slot from the one or more slots to monitor for at least one subsequent transmission associated with the RACH procedure; and receiving the at least one subsequent transmission in the at least one second slot in accordance with the at least one rule.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIGS. 5A, 5B, and 5C depict various examples of full duplex (FD) time/frequency resource configurations.

FIGS. 6A, 6B, and 6C depict various examples of full duplex configurations.

FIGS. 7A and 7B depict an example of inter-UE cross link interference (CLI).

FIG. 8 depicts an example of an FD base station performing simultaneous transmission and reception.

FIGS. 9A and 9B depict example uplink and downlink subbands for subband FD (SBFD) operations.

FIG. 10 depicts a call flow diagram illustrating a 4-step random access channel (RACH) procedure.

FIG. 11 depicts a call flow diagram illustrating techniques for preamble and PUSCH transmission for RACH procedures in SBFD networks, in accordance with aspects of the present disclosure.

FIG. 12 depicts PUSCH transmission in a half-duplex (HD) configuration when preamble transmission is limited to a particular slot type/configuration.

FIG. 13 depicts PUSCH transmission in an SBFD configuration when preamble transmission is limited to a particular slot type/configuration.

FIG. 14 depicts PUSCH transmission in an SBFD-aware configuration when preamble transmissions can alternate between configurations.

FIG. 15 depicts PUSCH transmission in an HD configuration when preamble transmissions can alternate between configurations.

FIG. 16 depicts a method for wireless communications.

FIG. 17 depicts a method for wireless communications.

FIG. 18 depicts aspects of an example communications device.

### DETAILED DESCRIPTION

Aspects of the present disclosure provide apparatuses, methods, processing systems, and computer-readable mediums for preamble and physical uplink shared channel (PUSCH) transmission associated with random access channel (RACH) procedures in subband full duplex (SBFD) networks.

The term full duplex (FD) generally refers to simultaneous transmission and reception over a wireless medium. An FD device is, thus, capable of processing bi-directional transmissions at the same time. In contrast, a half-duplex (HD) device is only capable of transmitting or receiving, at one time, but not both.

If a user equipment (UE) is operating in HD mode and a network entity, such as a gNodeB (gNB), is operating in an FD mode, such as sub-band FD (SBFD) or in-band FD (IBFD), interference may occur at the UE and gNB from a number of sources. For example, this interference may include inter-cell interference (ICI) from other gNBs, intra-cell cross-link interference (CLI) from UEs in the same cell, and inter-cell CLI from UEs in adjacent cells. Self-interference may also occur for both FD UEs and FD gNBs. In the case of FD gNBs, for example, self-interference may refer to a downlink transmission interfering with reception of an uplink transmission. These sources of interference may cause significant issues, including decreased spectral efficiency, increased power consumption, and poor UE performance.

In SBFD communication, guard bands may be used to separate frequency resources allocated for downlink (DL) and uplink (UL) signaling. In SBFD, the downlink and uplink signals may be transmitted on different subbands within the same frequency band. The guard band is a portion of the spectrum that is not used for either downlink or uplink communication, but is instead reserved to separate the subbands used for downlink and uplink signaling, preventing interference between them and allowing for a more reliable and efficient use of the available spectrum.

A random-access channel (RACH) is so named because it refers to a wireless channel (medium) that may be shared by multiple UEs and used by the UEs to (randomly) access the network for communications. For example, the RACH may be used for call setup and to access the network for data transmissions. In some cases, RACH may be used for initial access to a network when the UE switches from a radio resource control (RRC) connected idle mode to active mode, or when handing over in RRC connected mode. Moreover, RACH may be used for downlink (DL) and/or uplink (UL) data arrival when the UE is in RRC idle or RRC inactive modes, and when reestablishing a connection with the network.

In a four-step RACH procedure, a first message (MSG1) (e.g., including a RACH preamble) may be sent from the UE to a network entity (e.g., a BS such as a gNB) on the physical random access channel (PRACH). The network entity may respond with a random access response (RAR) message (MSG2) which may include the identifier (ID) of the RACH preamble, a timing advance (TA), an uplink grant, and/or control information. In response to MSG2, MSG3 is transmitted from the UE to the network entity on the PUSCH. MSG3 may include one or more of a RRC connection request, a tracking area update request, a system information request, a positioning fix or positioning signal request, or a scheduling request. The network entity then responds with MSG4 which may include a contention resolution message. In some cases, a two-step RACH procedure may be used. In such cases, MSG1 and MSG3 may be effectively combined into a message referred to as msgA, while MSG2 and MSG4 may be effectively combined into a message referred to as msgB.

However, there may be some ambiguity regarding RACH procedures (e.g., preamble and PUSCH transmission) in SBFD networks and the corresponding configuration. Configuration options include a single configuration with valid RACH occasions (ROs) in SBFD slots or separate legacy configurations and SBFD-aware configurations. However, using either configuration option, the relationship between MSG1 and MSG3 transmission may be unclear.

For example, if MSG1 is sent in HD slot(s), it may be unclear how an associated MSG3 is to be transmitted (e.g., whether in HD slots or FD slots). If preamble retransmissions are allowed to switch between slot types/configurations, it may be unclear how that affects MSG3 transmission (e.g., whether an MSG3 transmission should follow a certain rule or whether it should be left to UE implementation). Since parameters of MSG3 transmissions typically relate to MSG1 transmission (e.g., the preamble group determines the buffer size of MSG3 and the transmission power of MSG1 impacts the power of MSG3), it may be important to address these ambiguities.

Aspects of the present disclosure provide techniques for preamble and PUSCH transmission for RACH procedures in SBFD networks. Utilization of the techniques disclosed herein may resolve the aforementioned ambiguities, allowing for standardization and improving efficiency of RACH procedures and overall quality of service (QoS) and user experience.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

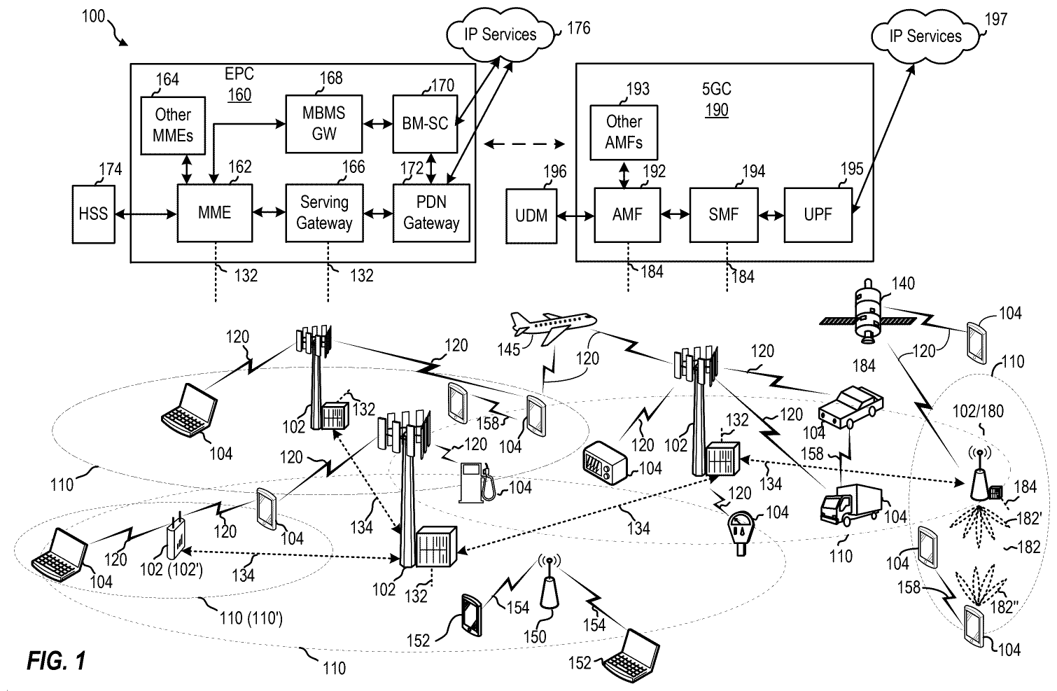

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

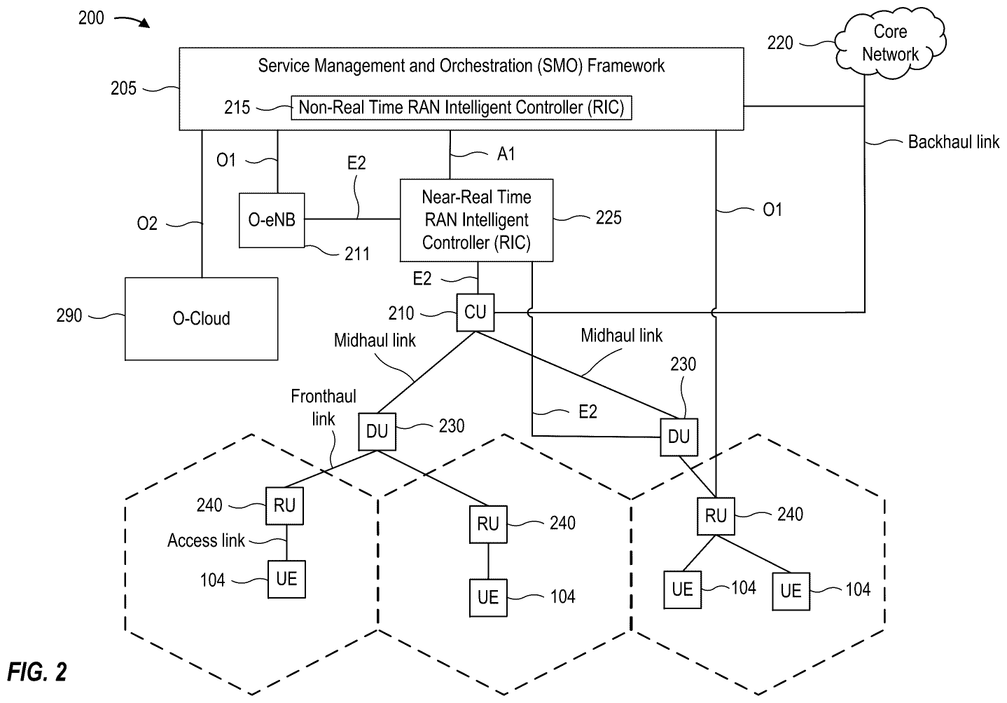

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz -7125 MHz, which is often referred to (interchangeably) as “Sub-6 GHz”. Similarly, 3GPP currently defines Frequency Range 2 (FR2) as including 24,250 MHz -71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz -52,600 MHz and a second sub-range FR2-2 including 52,600 MHz -71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

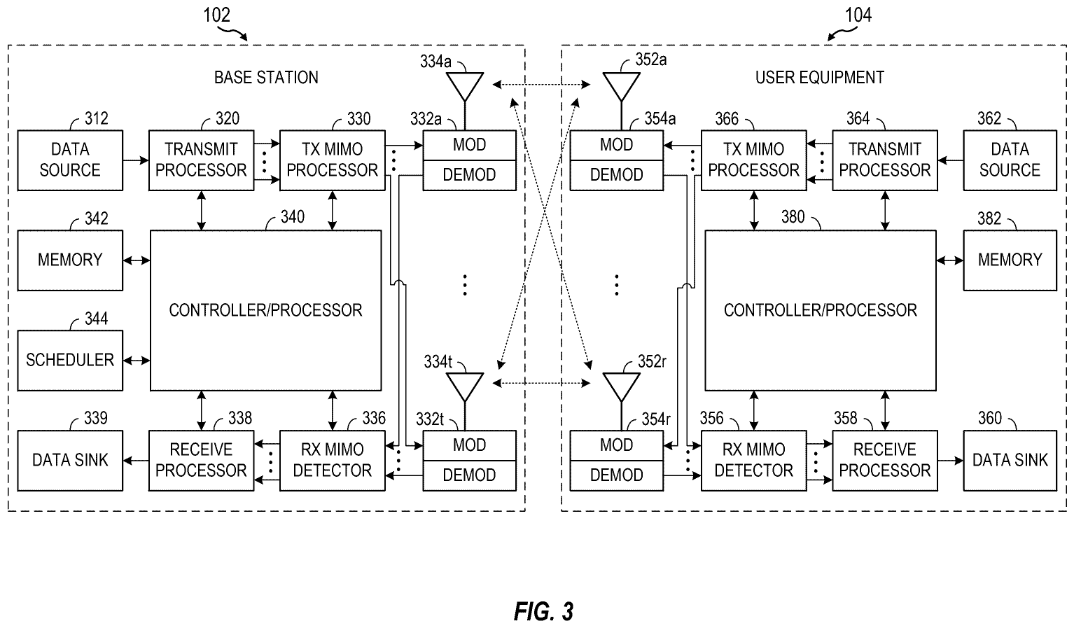

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

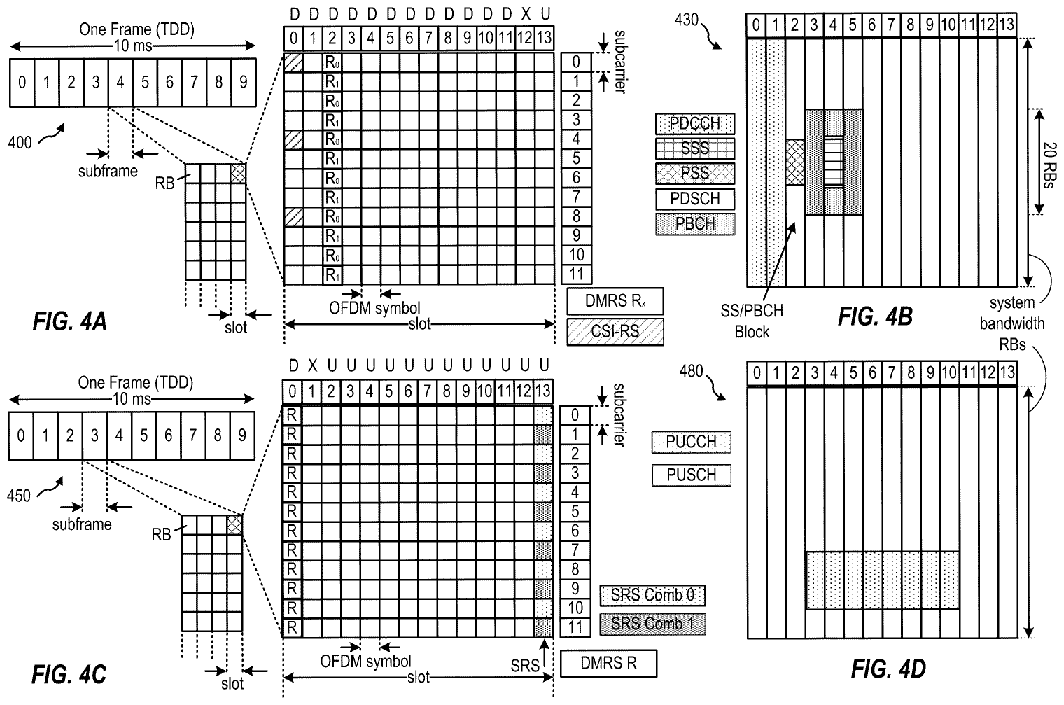

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Full Duplex Communication

As noted above, a full-duplex (FD) device is capable of simultaneous bi-directional communications. In contrast, half-duplex (HD) devices are only capable of communications in one direction (transmit or receive) at one time.

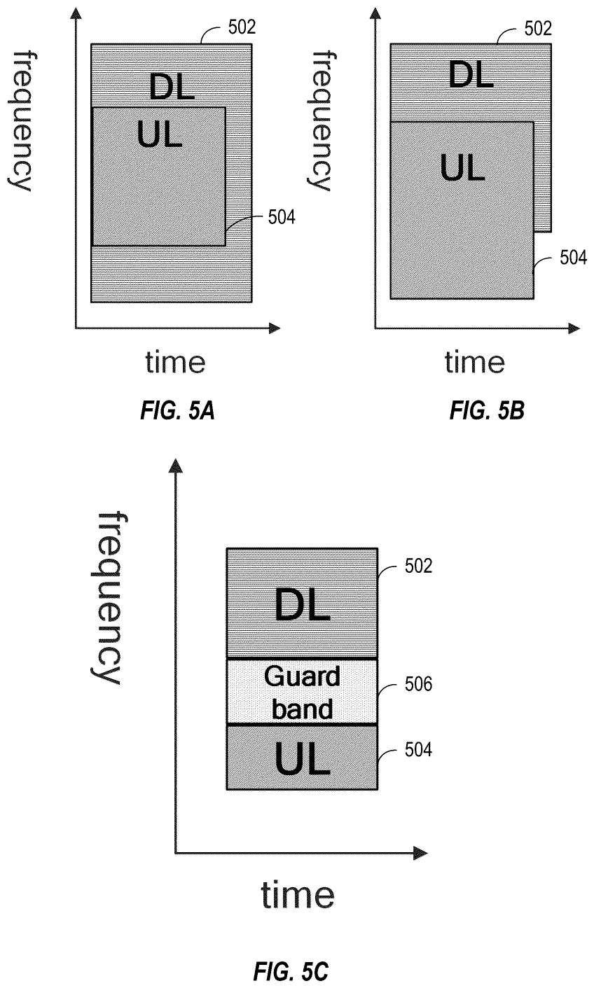

Examples of FD communication modes include in-band FD (IBFD) and sub-band FD. As illustrated in FIGS. 5A and 5B, with IBFD, a device may transmit and receive on the same time and frequency resources. In this case, the downlink (DL) 502 and uplink (UL) 504 shares the same IBFD time and frequency resources which may fully overlap (FIG. 5A) or partially overlap (FIG. 5B).

As shown in FIG. 5C, with SBFD (also referred to a flexible duplexing), a device may transmit and receive at the same time, but using different frequency resources. In this case, the DL resource may be separated from the UL resource, in frequency domain, by a guard band 506.

Interference to a UE and/or a network entity (e.g., a base station such as a gNB or node of a disaggregated base station) operating in FD mode may come in the form of CLI from neighboring nodes, as well as self-interference (SI). FIG. 5A, FIG. 5B, FIG. 5C, and FIG. 5D illustrate example interference scenarios for various FD communication use cases.

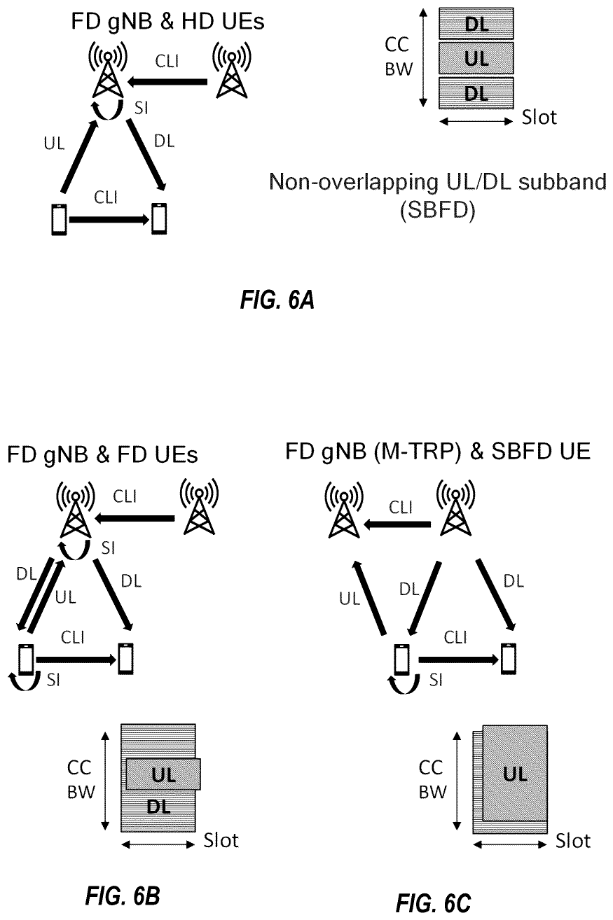

As illustrated in FIG. 6A, a first scenario is when FD is enabled for a gNB (e.g., with non-overlapping UL/DL subbands) but disabled for each connected UE (which in turn may be enabled for half-duplex (HD) communication), a gNB communicates using FD capabilities. In this case, CLI between UEs, SI from the FD gNB, and CLI between the gNB and neighboring gNBs interferes with FD communication.

As illustrated in FIG. 6B, a second scenario is when FD is enabled for both a gNB and a FD UE/customer premise equipment (CPE) connected to the gNB, the gNB communicates with the FD UE using FD capabilities. If the gNB is connected to an HD UE alongside the FD UE, the gNB communicates with the HD UE. In this case, CLI between UEs, SI from the gNB and the FD UE, and CLI between the FD gNB and neighboring gNBs interferes with FD communication.

As illustrated in FIG. 6C, a third scenario is when FD is enabled for two gNBs (e.g., in a multiple TRP scenario) and enabled at one UE/CPE connected to the two gNBs. In this case, the two gNBs may communicate with the FD UE using FD capabilities. If one of the two gNBs is connected to an HD UE alongside the FD UE, the one gNB communicates with both the HD UE and the FD UE. In this case, CLI between UEs, SI from the FD UE, and CLI between the two gNBs may interfere with FD communication.

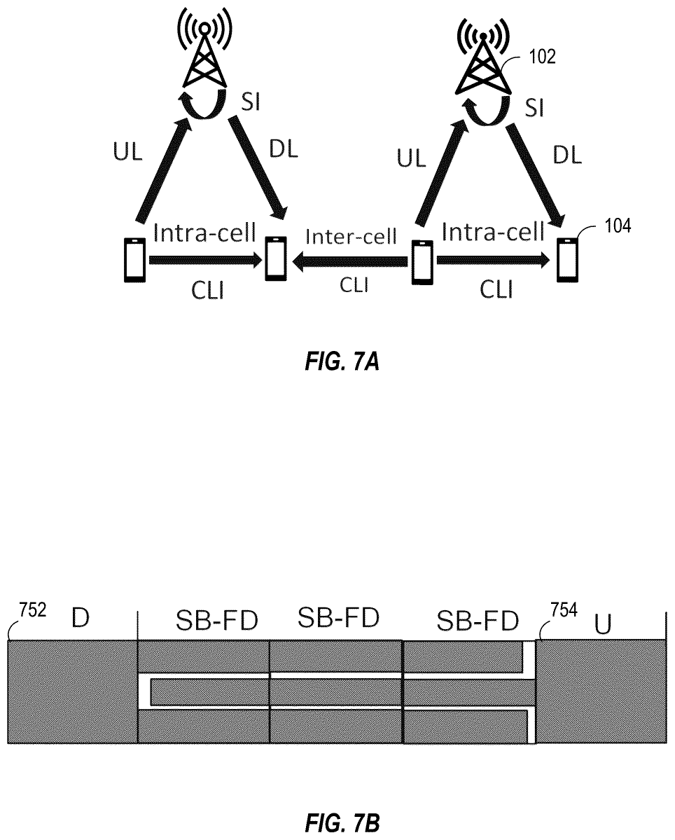

FIG. 7A also illustrates various forms of interference for FD communications. As illustrated, if a UE 104 is operating in HD mode and a gNB 102 is operating in FD (mode) SBFD/IBFD, sources of interference at the UE include inter-cell interference from other gNBs, intra-cell CLI from UEs in the same cell, and inter-cell CLI from UEs in adjacent cells. Additionally, there may be self-interference for full-duplex UEs, particularly in SBFD slots that include both uplink subbands 754 and downlink subbands 752, as shown in FIG. 7B.

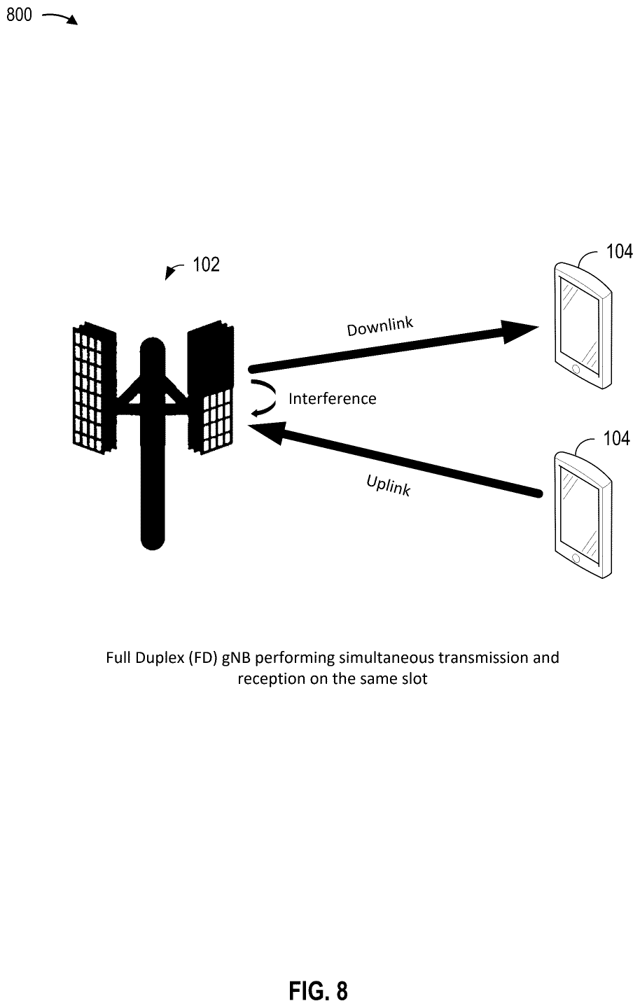

As noted above, an FD enabled device is capable of bi-directional network data transmissions at the same time. FIG. 8 illustrates an example of an FD enabled base station (an FD gNB) performing simultaneous transmission and reception on a same slot. As shown, the FD gNB may simultaneously perform a downlink transmission and receive an uplink transmission. As illustrated, the downlink transmission may be intended for a first UE, and the uplink transmission may be received from a second UE. In some cases, the downlink transmission and uplink transmission may both be associated with the same UE (e.g., if the UE is an FD UE). The simultaneous transmission and reception in a same slot may cause interference, as illustrated.

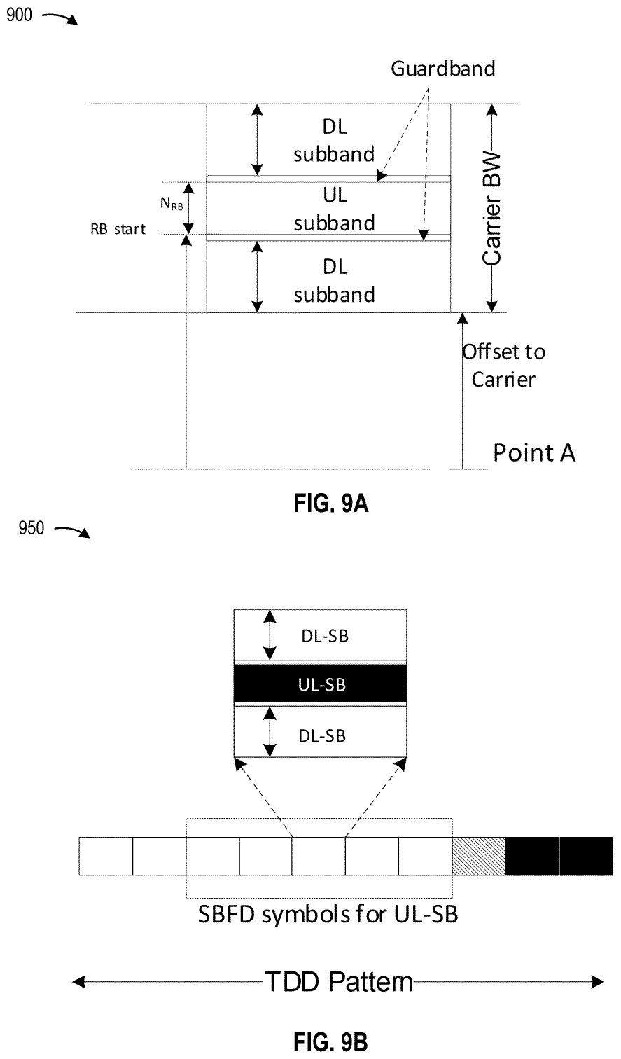

FIGS. 9A and 9B depict example uplink (UL) and downlink (DL) subbands for SBFD operations.

As illustrated in FIG. 9A, for example, UL and DL subbands may be allocated for SBFD operations within a carrier bandwidth (BW). As illustrated, for example, an UL subband allocation (e.g., and/or a DL subband allocation) may span N_{RB} resource blocks (RBs). As noted above, and as illustrated, UL subbands and DL subbands may be separated by guard bands.

As illustrated in FIG. 9B, a time division duplexing (TDD) pattern may indicate a semi-static configuration of subband time locations for SBFD operation. In such cases, frequency locations of DL subband(s) may be explicitly configured with guardband(s), if any, implicitly derived as RBs which are not within UL subband or DL subband(s). In other cases, a number of RBs for guardband(s), if any, is explicitly configured. In such cases, DL subband(s) may be implicitly derived as RBs which are not within UL subband or guardband(s).

### Example Rach Procedures

A random-access channel (RACH) is so named because it refers to a wireless channel (medium) that may be shared by multiple UEs and used by the UEs to (randomly) access the network for communications. For example, the RACH may be used for call setup and to access the network for data transmissions. In some cases, RACH may be used for initial access to a network when the UE switches from a radio resource control (RRC) connected idle mode to active mode, or when handing over in RRC connected mode. Moreover, RACH may be used for downlink (DL) and/or uplink (UL) data arrival when the UE is in RRC idle or RRC inactive modes, and when reestablishing a connection with the network.

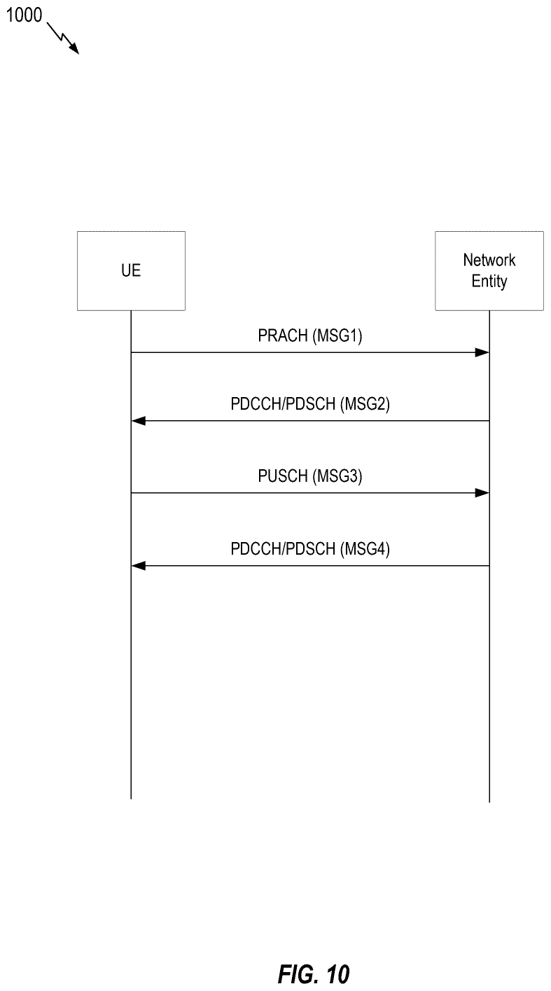

FIG. 10 is a timing (or “call-flow”) diagram 1000 illustrating an example four-step RACH procedure, in accordance with certain aspects of the present disclosure. A first message (MSG1) may be sent from the UE to a network entity (e.g., a BS such as a gNB) on the physical random access channel (PRACH). In this case, MSG1 may only include a RACH preamble. The network entity may respond with a random access response (RAR) message (MSG2) which may include the identifier (ID) of the RACH preamble, a timing advance (TA), an uplink grant, cell radio network temporary identifier (C-RNTI), and a back off indicator. MSG2 may include a PDCCH communication including control information for a following communication on the PDSCH, as illustrated. In response to MSG2, MSG3 is transmitted from the UE to the network entity on the PUSCH. MSG3 may include one or more of a RRC connection request, a tracking area update request, a system information request, a positioning fix or positioning signal request, or a scheduling request. The network entity then responds with MSG 4 which may include a contention resolution message.

In some cases, to speed access, a two-step RACH procedure may be supported. As the name implies, the two-step RACH procedure may effectively “collapse” the four messages of the four-step RACH procedure into two messages.

### Aspects Related to RACH Procedures in SBFD Networks

As noted above, there is some ambiguity regarding RACH procedures (e.g., preamble and PUSCH transmission) in SBFD networks. Configuration options include a single configuration with valid RACH occasions (ROs) in SBFD slots or separate legacy configurations and SBFD-aware configurations. However, using either configuration option, the relationship between MSG1 and MSG3 transmission may be unclear under certain scenarios.

For example, if MSG1 is sent in HD slot(s), it may be unclear how MSG3 is to be transmitted (e.g., in HD slots or FD slots). If preamble retransmissions are allowed to switch between slot types/configurations, it may be unclear how that affects MSG3 transmission (e.g., MSG3 transmission could follow a certain rule or could be left to UE implementation). Since parameters of MSG3 transmissions typically relate, to some extent, on MSG1 transmission (e.g., the preamble group determines the buffer size of MSG3 and the transmission power of MSG1 impacts the power of MSG3), it may be beneficial to provide mechanisms that help address these ambiguities.

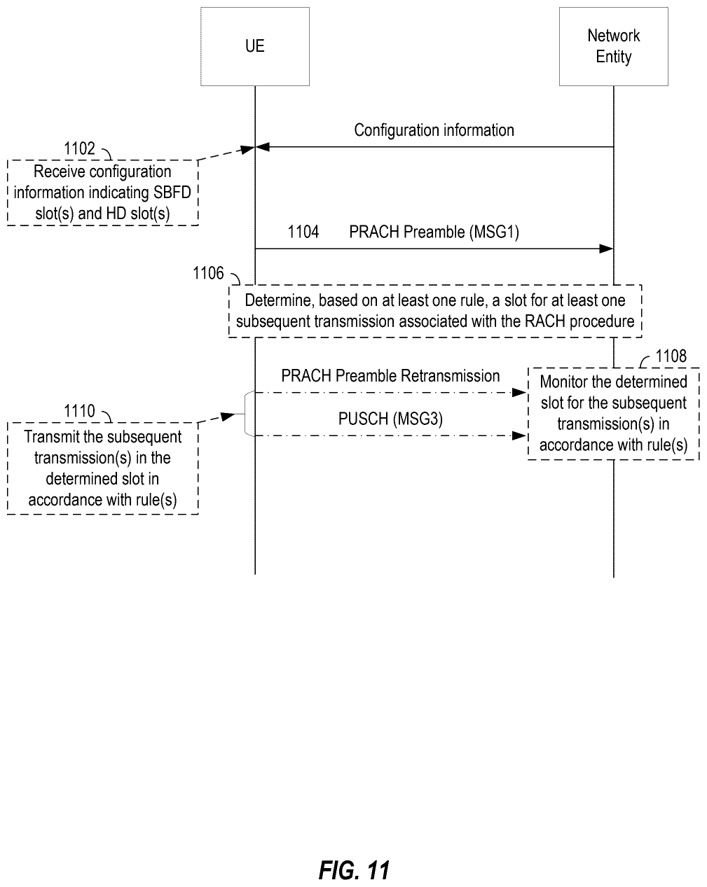

Aspects of the present disclosure provide techniques for preamble and PUSCH transmission for RACH procedures in SBFD networks. These techniques may be understood with reference to FIG. 11, which depicts a call flow diagram 1100 illustrating techniques for preamble and PUSCH transmission for RACH procedures in SBFD networks, in accordance with aspects of the present disclosure.

In some aspects, the UE shown in FIG. 11 may be an example of the UE 104 depicted and described with respect to FIGS. 1 and 3. In some aspects, the first and/or second network entity (e.g., RU and/or DU) shown in FIG. 11 may be an example of the BS 102 (e.g., a gNB) depicted and described with respect to FIGS. 1 and 3 or a disaggregated base station depicted and described with respect to FIG. 2.

In some aspects, as illustrated at 1102, the UE may receive configuration information indicating one or more slots including SBFD slot(s) and HD slot(s). As illustrated at 1104, the UE may transmit a (P)RACH preamble (e.g., MSG1) associated with a (P)RACH procedure, in accordance with the configuration information.

As illustrated at 1106, the UE and the network entity may determine, based on at least one rule, a slot for at least one subsequent transmission associated with the RACH procedure. As illustrated at 1108, the network entity may monitor the determined slot for the subsequent transmission(s), in accordance with the rule(s). As illustrated at 1110, the UE may transmit the subsequent transmission(s) in the determined slot in accordance with the rule(s).

In some aspects (e.g., according to the at least one rule described above with reference to call flow diagram 1100), preamble transmission and retransmissions may be limited to a slot type and/or to a specific configuration. For example, if a RACH preamble is transmitted on an HD slot, the rule may specify that RACH preamble retransmissions must also be transmitted on HD slots.

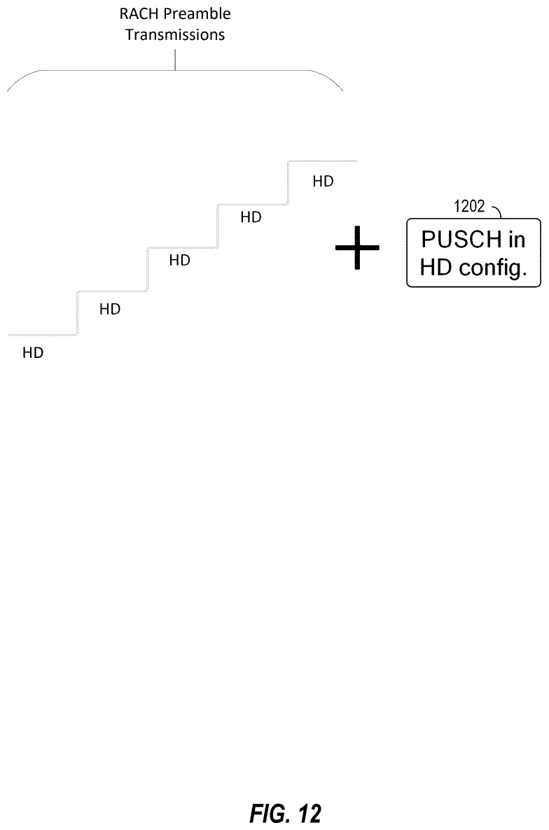

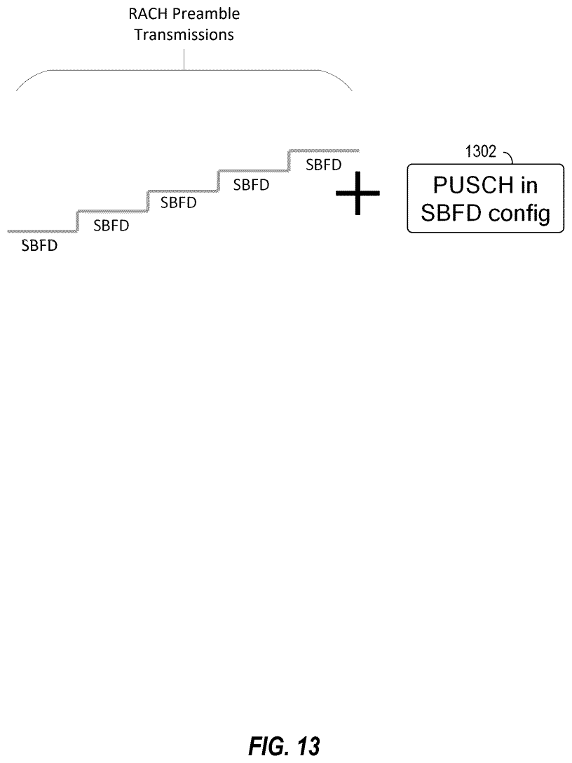

According to a first option (Option 1), the UE may transmit/retransmit msg3 PUSCH (e.g., or msgA PUSCH) according to the configuration of the preamble transmission (e.g., HD configuration if preamble transmissions were only in HD configurations) in accordance with certain rules. This first option may be understood with reference to FIG. 12, which depicts PUSCH transmission 1202 in an HD configuration when preamble transmission is limited to a particular slot type/configuration (HD configuration in this case) and FIG. 13, which depicts PUSCH transmission 1302 in an SBFD configuration when preamble transmission is limited to a particular slot type/configuration (SBFD configuration in this case).

According to a second option (Option 2), the UE may be allowed to transmit/retransmit msg3 PUSCH (e.g., or msgA PUSCH) according to either configuration (e.g., which may depend on the slot type in which the PUSCH is signaled in) in accordance with certain rules. In other words, according to Option 2, PUSCH transmission (e.g., and retransmission) may be transmitted according to either configuration (HD or SBFD) regardless of the configuration of the preamble transmission. In some cases, PUSCH retransmission may be required to be transmitted in a same slot type/configuration as the PUSCH transmission.

In some cases (e.g., in a 4-step RACH procedure), msg3 is scheduled by the network through msg2. Thus, when msg3 (e.g., PUSCH) is to be transmitted in an HD slot for example (e.g., in accordance with the rules/options described herein), the UE should expect that information to be specified in msg2 (e.g., and anything else should be considered as an error case).

In some aspects, available slots for PUSCH transmission may follow the same restrictions/rules as those applied for RACH preamble transmission. In some aspects, the msg3 configuration described above may be (not only about slot type, but also) related to DMRS configuration and power control, which is configuration dependent. For example, certain rules may specify that msg3 (e.g., PUSCH) is to be transmitted with a same DMRS configuration and/or power control as the PRACH preamble.

As illustrated in FIG. 12 and FIG. 13, there may be power control changes between a preamble transmission and a retransmission (illustrated by the power increment step sizes, which differ between FIG. 12 and FIG. 13). However, the power control parameters for the PUSCH configuration may be based on the power control parameters for the most recent preamble transmission/retransmission.

In some aspects (e.g., according to the at least one rule described above with reference to call flow diagram 1100), preamble transmission and preamble retransmissions may be transmitted in different slots/configurations. For example, if a RACH preamble is transmitted on an HD slot, the rule may allow for RACH preamble retransmissions to be transmitted on SBFD slots.

In such cases, the rules may dictate that a UE to transmit msg3 or msgA PUSCH according to the configuration of the last (most recent) preamble transmission (or retransmission). For example, if the last preamble (re)transmission was in an SBFD slot/configuration, then msg3 or msgA PUSCH should also be transmitted in an SBFD slot/configuration.

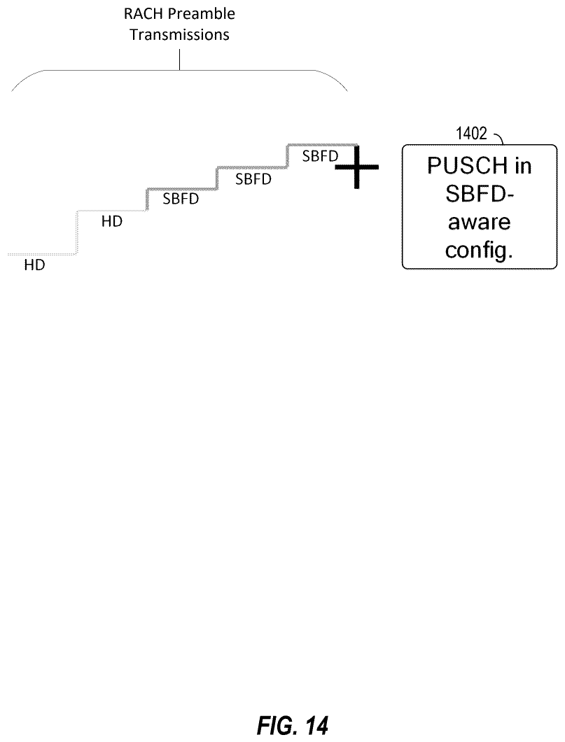

Such rules may be understood with reference to FIG. 14, which depicts PUSCH transmission 1402 in an SBFD-aware configuration when preamble transmissions can alternate between configurations. As illustrated, the first preamble transmission and retransmission were in an HD slot/configuration, and the remaining (and most recent) preamble retransmissions were in SBFD slots/configurations. Thus, in accordance with the rule(s), msg3 PUSCH is transmitted in a same configuration as the most recent RACH preamble (re)transmission (e.g., in an SBFD slot configuration).

Alternatively, or additionally, certain rules may dictate that a UE to transmit msg3 or msgA PUSCH according to the configuration of the majority of the preamble transmissions/retransmissions. For example, if more than 50% of preamble transmissions/retransmissions were in an SBFD slot/configuration, msg3 or msgA PUSCH should also be transmitted in an SBFD slot/configuration.

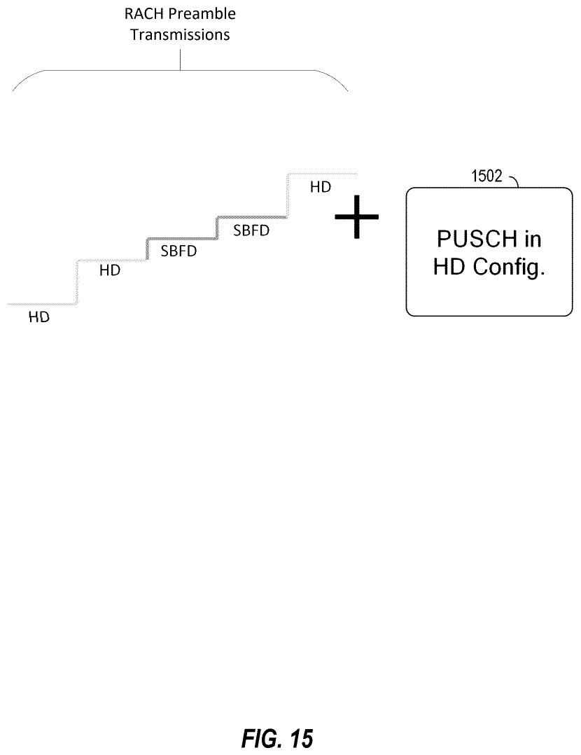

Such rules may be understood with reference to FIG. 15, which depicts PUSCH transmission 1502 in an HD configuration when preamble transmissions can alternate between configurations. As illustrated, a majority of preamble transmissions/retransmissions are in an HD slot/configuration. Thus, in accordance with the rules, the PUSCH is also transmitted in an HD slot/configuration.

As used herein, msg3 may refer to msg3 of a 4-step RACH procedure or a fallback msg3 of a 2-step RACH procedure (e.g., in the event a 2-step RACH procedure falls back to using messages of a 4-step RACH procedure).

In 5G NR, k2 refers to a parameter that specifies a timing offset in slots between the reception of Downlink Control Information (DCI) and the corresponding data transmission on the PUSCH. When a UE receives a DCI message on the PDCCH, k2 indicates how many slots later the scheduled uplink data transmission should occur. This timing flexibility may allow the network to efficiently manage and allocate resources, ensuring that uplink transmissions are appropriately timed following the control instructions received by the UE.

However, interpretation of k2 may depend on the slot availability for PUSCH transmission. For example, a legacy UE may be configured to not consider SBFD slots as valid, while an SBFD-aware UE may consider SBFD slots as valid for k2 slot counting purposes. In some aspects, msg2 (DCI) may indicate to the UE which slots to consider as valid for k2 slot counting purposes. In some aspects, for example, msg2 DCI/payload may include one or more bits indicating whether the UE should consider PUSCH available slots similar to a legacy UE (e.g., HD slots only), should consider only the SBFD slots, or both.

### Example Operations

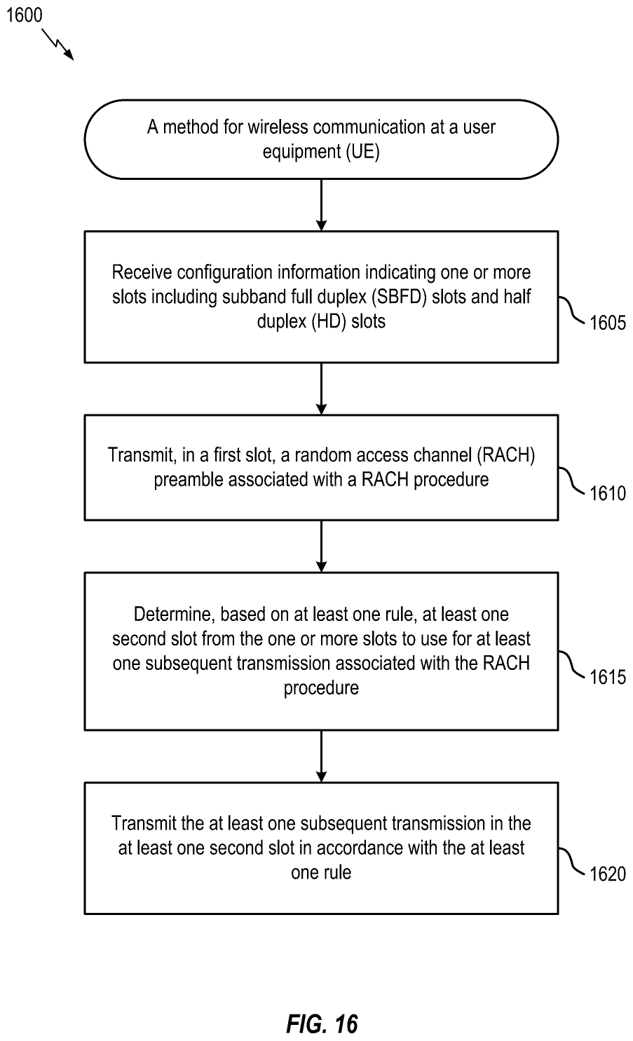

FIG. 16 shows an example of a method 1600 of wireless communication at a user equipment (UE), such as a UE 104 of FIGS. 1 and 3.

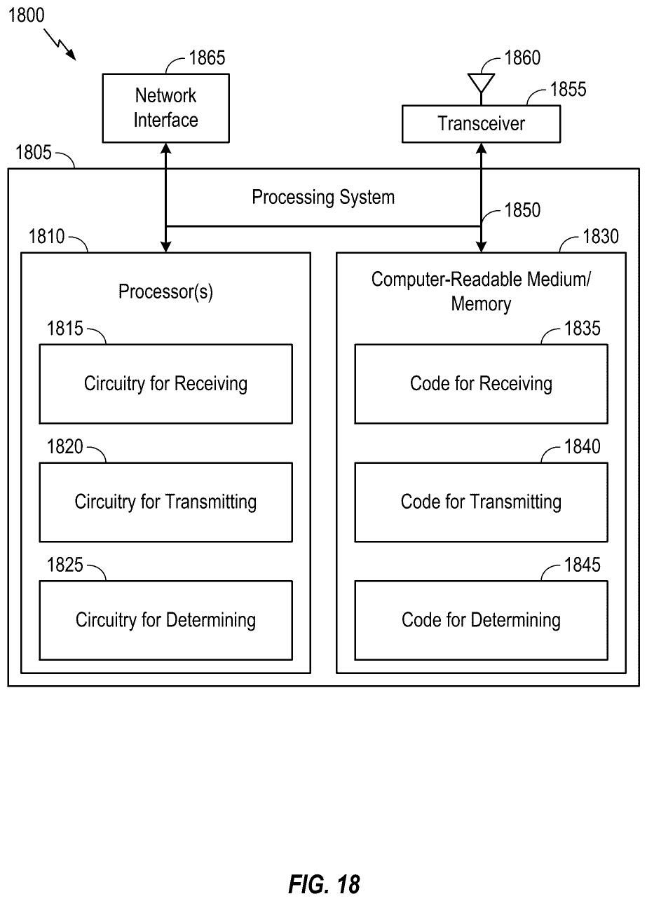

Method 1600 begins at step 1605 with receiving configuration information indicating one or more slots including subband full duplex (SBFD) slots and half duplex (HD) slots. In some cases, the operations of this step refer to, or may be performed by, circuitry for receiving and/or code for receiving as described with reference to FIG. 18.

Method 1600 then proceeds to step 1610 with transmitting, in a first slot, a random access channel (RACH) preamble associated with a RACH procedure. In some cases, the operations of this step refer to, or may be performed by, circuitry for transmitting and/or code for transmitting as described with reference to FIG. 18.

Method 1600 then proceeds to step 1615 with determining, based on at least one rule, at least one second slot from the one or more slots to use for at least one subsequent transmission associated with the RACH procedure. In some cases, the operations of this step refer to, or may be performed by, circuitry for determining and/or code for determining as described with reference to FIG. 18.

Method 1600 then proceeds to step 1620 with transmitting the at least one subsequent transmission in the at least one second slot in accordance with the at least one rule. In some cases, the operations of this step refer to, or may be performed by, circuitry for transmitting and/or code for transmitting as described with reference to FIG. 18.

In some aspects, the at least one subsequent transmission comprises at least one of: one or more RACH preamble retransmissions, or a physical uplink shared channel (PUSCH) transmission.

In some aspects, the at least one rule dictates that: when the first slot is configured as an SBFD slot, the one or more RACH preamble retransmissions are to be transmitted in an SBFD slot; and when the first slot is configured as an HD slot, the one or more RACH preamble retransmissions are to be transmitted in an HD slot.

In some aspects, the at least one rule dictates that: when the first slot is configured as an SBFD slot, the PUSCH transmission are to be transmitted in an SBFD slot; and when the first slot is configured as an HD slot, the PUSCH transmission are to be transmitted in an HD slot.

In some aspects, the at least one rule dictates that: the PUSCH transmission may be transmitted in an SBFD slot or an HD slot independent of whether the first slot is configured as an SBFD slot or an HD slot.

In some aspects, the at least one rule dictates that the one or more RACH preamble retransmissions may be transmitted in an SBFD slot or an HD slot independent of whether the first slot is configured as an SBFD slot or an HD slot.

In some aspects, the at least one rule dictates that: when a most recent of the RACH preamble transmission and the one or more RACH preamble retransmissions is transmitted in an SBFD slot, the PUSCH transmission is to be transmitted in an SBFD slot; and when a most recent of the RACH preamble transmission and the one or more RACH preamble retransmissions is transmitted in an HD slot, the PUSCH transmission is to be transmitted in an HD slot.

In some aspects, the at least one rule dictates that: when a majority of the RACH preamble transmission and the one or more RACH preamble retransmissions are transmitted in SBFD slots, the PUSCH transmission is to be transmitted in an SBFD slot; and when a majority of the RACH preamble transmission and the one or more RACH preamble retransmissions are transmitted in HD slots, the PUSCH transmission is to be transmitted in an HD slot.

In some aspects, the method 1600 further includes receiving signaling indicating a subset of the one or more slots to consider as available for use for the at least one subsequent transmission. In some cases, the operations of this step refer to, or may be performed by, circuitry for receiving and/or code for receiving as described with reference to FIG. 18.

In some aspects, the signaling is received after the UE transmits the RACH preamble.

In one aspect, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative steps are possible consistent with this disclosure.

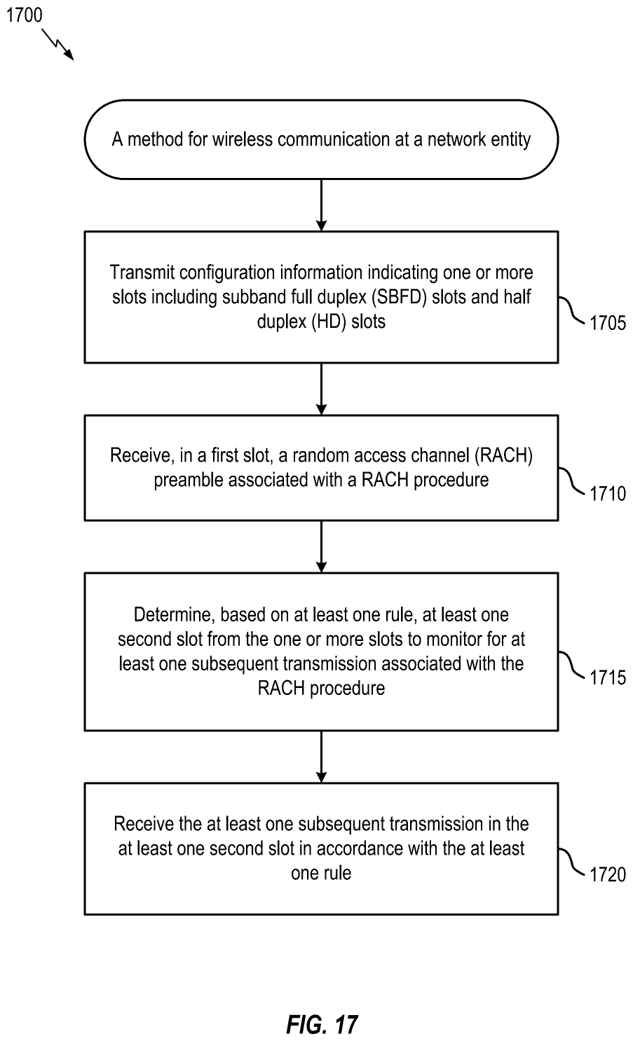

FIG. 17 shows an example of a method 1700 of wireless communication at a network entity, such as a BS 102 of FIGS. 1 and 3, or a disaggregated base station as discussed with respect to FIG. 2.

Method 1700 begins at step 1705 with transmitting configuration information indicating one or more slots including subband full duplex (SBFD) slots and half duplex (HD) slots. In some cases, the operations of this step refer to, or may be performed by, circuitry for transmitting and/or code for transmitting as described with reference to FIG. 18.

Method 1700 then proceeds to step 1710 with receiving, in a first slot, a random access channel (RACH) preamble associated with a RACH procedure. In some cases, the operations of this step refer to, or may be performed by, circuitry for receiving and/or code for receiving as described with reference to FIG. 18.

Method 1700 then proceeds to step 1715 with determining, based on at least one rule, at least one second slot from the one or more slots to monitor for at least one subsequent transmission associated with the RACH procedure. In some cases, the operations of this step refer to, or may be performed by, circuitry for determining and/or code for determining as described with reference to FIG. 18.

Method 1700 then proceeds to step 1720 with receiving the at least one subsequent transmission in the at least one second slot in accordance with the at least one rule. In some cases, the operations of this step refer to, or may be performed by, circuitry for receiving and/or code for receiving as described with reference to FIG. 18.

In some aspects, the at least one subsequent transmission comprises at least one of: one or more RACH preamble retransmissions, or a physical uplink shared channel (PUSCH) transmission.

In some aspects, the at least one rule dictates that: when the first slot is configured as an SBFD slot, the one or more RACH preamble retransmissions are to be transmitted in an SBFD slot; and when the first slot is configured as an HD slot, the one or more RACH preamble retransmissions are to be transmitted in an HD slot.

In some aspects, the at least one rule dictates that: when the first slot is configured as an SBFD slot, the PUSCH transmission are to be transmitted in an SBFD slot; and when the first slot is configured as an HD slot, the PUSCH transmission are to be transmitted in an HD slot.

In some aspects, the at least one rule dictates that: the PUSCH transmission may be transmitted in an SBFD slot or an HD slot independent of whether the first slot is configured as an SBFD slot or an HD slot.

In some aspects, the at least one rule dictates that the one or more RACH preamble retransmissions may be transmitted in an SBFD slot or an HD slot independent of whether the first slot is configured as an SBFD slot or an HD slot.

In some aspects, the at least one rule dictates that: when a most recent of the RACH preamble transmission and the one or more RACH preamble retransmissions is transmitted in an SBFD slot, the PUSCH transmission is to be transmitted in an SBFD slot; and when a most recent of the RACH preamble transmission and the one or more RACH preamble retransmissions is transmitted in an HD slot, the PUSCH transmission is to be transmitted in an HD slot.

In some aspects, the at least one rule dictates that: when a majority of the RACH preamble transmission and the one or more RACH preamble retransmissions are transmitted in SBFD slots, the PUSCH transmission is to be transmitted in an SBFD slot; and when a majority of the RACH preamble transmission and the one or more RACH preamble retransmissions are transmitted in HD slots, the PUSCH transmission is to be transmitted in an HD slot.

In some aspects, the method 1700 further includes transmitting signaling indicating a subset of the one or more slots to consider as available for use for the at least one subsequent transmission. In some cases, the operations of this step refer to, or may be performed by, circuitry for transmitting and/or code for transmitting as described with reference to FIG. 18.

In some aspects, the signaling is transmitted after the network entity receives the RACH preamble.

In one aspect, method 1700, or any aspect related to it, may be performed by an apparatus, such as communications device 1800 of FIG. 18, which includes various components operable, configured, or adapted to perform the method 1700. Communications device 1800 is described below in further detail.

Note that FIG. 17 is just one example of a method, and other methods including fewer, additional, or alternative steps are possible consistent with this disclosure.

### Example Communications Device(s)

FIG. 18 depicts aspects of an example communications device 1800. In some aspects, communications device 1800 is a user equipment, such as UE 104 described above with respect to FIGS. 1 and 3. In some aspects, communications device 1800 is a network entity, such as BS 102 of FIGS. 1 and 3, or a disaggregated base station as discussed with respect to FIG. 2.

The communications device 1800 includes a processing system 1805 coupled to the transceiver 1855 (e.g., a transmitter and/or a receiver). In some aspects (e.g., when communications device 1800 is a network entity), processing system 1805 may be coupled to a network interface 1865 that is configured to obtain and send signals for the communications device 1800 via communication link(s), such as a backhaul link, midhaul link, and/or fronthaul link as described herein, such as with respect to FIG. 2. The transceiver 1855 is configured to transmit and receive signals for the communications device 1800 via the antenna 1860, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. In various aspects, one or more processors 1810 may be representative of one or more of receive processor 338, transmit processor 320, TX MIMO processor 330, and/or controller/processor 340, as described with respect to FIG. 3. The one or more processors 1810 are coupled to a computer-readable medium/memory 1830 via a bus 1850. In certain aspects, the computer-readable medium/memory 1830 is configured to store instructions (e.g., computer-executable code) that when executed by the one or more processors 1810, cause the one or more processors 1810 to perform the method 1600 described with respect to FIG. 16, or any aspect related to it; and the method 1700 described with respect to FIG. 17, or any aspect related to it. Note that reference to a processor performing a function of communications device 1800 may include one or more processors 1810 performing that function of communications device 1800.

In the depicted example, computer-readable medium/memory 1830 stores code (e.g., executable instructions), such as code for receiving 1835, code for transmitting 1840, and code for determining 1845. Processing of the code for receiving 1835, code for transmitting 1840, and code for determining 1845 may cause the communications device 1800 to perform the method 1600 described with respect to FIG. 16, or any aspect related to it; and the method 1700 described with respect to FIG. 17, or any aspect related to it.

The one or more processors 1810 include circuitry configured to implement (e.g., execute) the code stored in the computer-readable medium/memory 1830, including circuitry for receiving 1815, circuitry for transmitting 1820, and circuitry for determining 1825. Processing with circuitry for receiving 1815, circuitry for transmitting 1820, and circuitry for determining 1825 may cause the communications device 1800 to perform the method 1600 described with respect to FIG. 16, or any aspect related to it; and the method 1700 described with respect to FIG. 17, or any aspect related to it.

Various components of the communications device 1800 may provide means for performing the method 1600 described with respect to FIG. 16, or any aspect related to it; and the method 1700 described with respect to FIG. 17, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1855 and the antenna 1860 of the communications device 1800 in FIG. 18. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1855 and the antenna 1860 of the communications device 1800 in FIG. 18.

### Example Clauses

Implementation examples are described in the following numbered clauses:
Clause 1: A method for wireless communication at a user equipment (UE), comprising: receiving configuration information indicating one or more slots including subband full duplex (SBFD) slots and half duplex (HD) slots; transmitting, in a first slot, a random access channel (RACH) preamble associated with a RACH procedure; determining, based on at least one rule, at least one second slot from the one or more slots to use for at least one subsequent transmission associated with the RACH procedure; and transmitting the at least one subsequent transmission in the at least one second slot in accordance with the at least one rule.
Clause 2: The method of Clause 1, wherein the at least one subsequent transmission comprises at least one of: one or more RACH preamble retransmissions, or a physical uplink shared channel (PUSCH) transmission.
Clause 3: The method of Clause 2, wherein the at least one rule dictates that: when the first slot is configured as an SBFD slot, the one or more RACH preamble retransmissions are to be transmitted in an SBFD slot; and when the first slot is configured as an HD slot, the one or more RACH preamble retransmissions are to be transmitted in an HD slot.
Clause 4: The method of Clause 3, wherein the at least one rule dictates that: when the first slot is configured as an SBFD slot, the PUSCH transmission are to be transmitted in an SBFD slot; and when the first slot is configured as an HD slot, the PUSCH transmission are to be transmitted in an HD slot.
Clause 5: The method of Clause 3, wherein the at least one rule dictates that: the PUSCH transmission may be transmitted in an SBFD slot or an HD slot independent of whether the first slot is configured as an SBFD slot or an HD slot.
Clause 6: The method of Clause 2, wherein the at least one rule dictates that the one or more RACH preamble retransmissions may be transmitted in an SBFD slot or an HD slot independent of whether the first slot is configured as an SBFD slot or an HD slot.
Clause 7: The method of Clause 6, wherein the at least one rule dictates that: when a most recent of the RACH preamble transmission and the one or more RACH preamble retransmissions is transmitted in an SBFD slot, the PUSCH transmission is to be transmitted in an SBFD slot; and when a most recent of the RACH preamble transmission and the one or more RACH preamble retransmissions is transmitted in an HD slot, the PUSCH transmission is to be transmitted in an HD slot.
Clause 8: The method of Clause 6, wherein the at least one rule dictates that: when a majority of the RACH preamble transmission and the one or more RACH preamble retransmissions are transmitted in SBFD slots, the PUSCH transmission is to be transmitted in an SBFD slot; and when a majority of the RACH preamble transmission and the one or more RACH preamble retransmissions are transmitted in HD slots, the PUSCH transmission is to be transmitted in an HD slot.
Clause 9: The method of any one of Clauses 1-8, further comprising receiving signaling indicating a subset of the one or more slots to consider as available for use for the at least one subsequent transmission.
Clause 10: The method of Clause 9, wherein the signaling is received after the UE transmits the RACH preamble.
Clause 11: A method for wireless communication at a network entity, comprising: transmitting configuration information indicating one or more slots including subband full duplex (SBFD) slots and half duplex (HD) slots; receiving, in a first slot, a random access channel (RACH) preamble associated with a RACH procedure; determining, based on at least one rule, at least one second slot from the one or more slots to monitor for at least one subsequent transmission associated with the RACH procedure; and receiving the at least one subsequent transmission in the at least one second slot in accordance with the at least one rule.
Clause 12: The method of Clause 11, wherein the at least one subsequent transmission comprises at least one of: one or more RACH preamble retransmissions, or a physical uplink shared channel (PUSCH) transmission.
Clause 13: The method of Clause 12, wherein the at least one rule dictates that: when the first slot is configured as an SBFD slot, the one or more RACH preamble retransmissions are to be transmitted in an SBFD slot; and when the first slot is configured as an HD slot, the one or more RACH preamble retransmissions are to be transmitted in an HD slot.
Clause 14: The method of Clause 13, wherein the at least one rule dictates that: when the first slot is configured as an SBFD slot, the PUSCH transmission are to be transmitted in an SBFD slot; and when the first slot is configured as an HD slot, the PUSCH transmission are to be transmitted in an HD slot.
Clause 15: The method of Clause 13, wherein the at least one rule dictates that: the PUSCH transmission may be transmitted in an SBFD slot or an HD slot independent of whether the first slot is configured as an SBFD slot or an HD slot.
Clause 16: The method of Clause 12, wherein the at least one rule dictates that the one or more RACH preamble retransmissions may be transmitted in an SBFD slot or an HD slot independent of whether the first slot is configured as an SBFD slot or an HD slot.
Clause 17: The method of Clause 16, wherein the at least one rule dictates that: when a most recent of the RACH preamble transmission and the one or more RACH preamble retransmissions is transmitted in an SBFD slot, the PUSCH transmission is to be transmitted in an SBFD slot; and when a most recent of the RACH preamble transmission and the one or more RACH preamble retransmissions is transmitted in an HD slot, the PUSCH transmission is to be transmitted in an HD slot.
Clause 18: The method of Clause 16, wherein the at least one rule dictates that: when a majority of the RACH preamble transmission and the one or more RACH preamble retransmissions are transmitted in SBFD slots, the PUSCH transmission is to be transmitted in an SBFD slot; and when a majority of the RACH preamble transmission and the one or more RACH preamble retransmissions are transmitted in HD slots, the PUSCH transmission is to be transmitted in an HD slot.
Clause 19: The method of any one of Clauses 11-18, further comprising transmitting signaling indicating a subset of the one or more slots to consider as available for use for the at least one subsequent transmission.
Clause 20: The method of Clause 19, wherein the signaling is transmitted after the network entity receives the RACH preamble.
Clause 21: An apparatus, comprising: at least one memory comprising executable instructions; and at least one processor configured to execute the executable instructions and cause the apparatus to perform a method in accordance with any combination of Clauses 1-20.
Clause 22: An apparatus, comprising means for performing a method in accordance with any combination of Clauses 1-20.
Clause 23: A non-transitory computer-readable medium comprising executable instructions that, when executed by at least one processor of an apparatus, cause the apparatus to perform a method in accordance with any combination of Clauses 1-20.
Clause 24: A computer program product embodied on a computer-readable storage medium comprising code for performing a method in accordance with any combination of Clauses 1-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for receiving, means for transmitting, and means for determining may comprise one or more processors, such as one or more of the processors described above with reference to FIG. 18.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
at least one memory comprising computer-executable instructions; and
one or more processors configured to execute the computer-executable instructions and cause the apparatus to:
receive configuration information indicating one or more slots including subband full duplex (SBFD) slots and half duplex (HD) slots;
transmit, in a first slot, a random access channel (RACH) preamble associated with a RACH procedure;
determine, based on at least one rule, at least one second slot from the one or more slots to use for at least one subsequent transmission associated with the RACH procedure; and
transmit the at least one subsequent transmission in the at least one second slot in accordance with the at least one rule.

2. The apparatus of claim 1, wherein the at least one subsequent transmission comprises at least one of:
one or more RACH preamble retransmissions, or
a physical uplink shared channel (PUSCH) transmission.

3. The apparatus of claim 2, wherein the at least one rule dictates that:
when the first slot is configured as an SBFD slot, the one or more RACH preamble retransmissions are to be transmitted in an SBFD slot; and
when the first slot is configured as an HD slot, the one or more RACH preamble retransmissions are to be transmitted in an HD slot.

4. The apparatus of claim 3, wherein the at least one rule dictates that:
when the first slot is configured as an SBFD slot, the PUSCH transmission are to be transmitted in an SBFD slot; and
when the first slot is configured as an HD slot, the PUSCH transmission are to be transmitted in an HD slot.

5. The apparatus of claim 3, wherein the at least one rule dictates that:
the PUSCH transmission may be transmitted in an SBFD slot or an HD slot independent of whether the first slot is configured as an SBFD slot or an HD slot.

6. The apparatus of claim 2, wherein the at least one rule dictates that the one or more RACH preamble retransmissions may be transmitted in an SBFD slot or an HD slot independent of whether the first slot is configured as an SBFD slot or an HD slot.

7. The apparatus of claim 6, wherein the at least one rule dictates that:
when a most recent of the RACH preamble transmission and the one or more RACH preamble retransmissions is transmitted in an SBFD slot, the PUSCH transmission is to be transmitted in an SBFD slot; and
when a most recent of the RACH preamble transmission and the one or more RACH preamble retransmissions is transmitted in an HD slot, the PUSCH transmission is to be transmitted in an HD slot.

8. The apparatus of claim 6, wherein the at least one rule dictates that:
when a majority of the RACH preamble transmission and the one or more RACH preamble retransmissions are transmitted in SBFD slots, the PUSCH transmission is to be transmitted in an SBFD slot; and
when a majority of the RACH preamble transmission and the one or more RACH preamble retransmissions are transmitted in HD slots, the PUSCH transmission is to be transmitted in an HD slot.

9. The apparatus of claim 1, wherein the one or more processors are further configured to cause the apparatus to:
receive signaling indicating a subset of the one or more slots to consider as available for use for the at least one subsequent transmission.

10. The apparatus of claim 9, wherein the signaling is received after the UE transmits the RACH preamble.

11. An apparatus for wireless communication at a network entity, comprising:
at least one memory comprising computer-executable instructions; and
one or more processors configured to execute the computer-executable instructions and cause the apparatus to:
transmit configuration information indicating one or more slots including subband full duplex (SBFD) slots and half duplex (HD) slots;
receive, in a first slot, a random access channel (RACH) preamble associated with a RACH procedure;
determine, based on at least one rule, at least one second slot from the one or more slots to monitor for at least one subsequent transmission associated with the RACH procedure; and
receive the at least one subsequent transmission in the at least one second slot in accordance with the at least one rule.

12. The apparatus of claim 11, wherein the at least one subsequent transmission comprises at least one of:
one or more RACH preamble retransmissions, or
a physical uplink shared channel (PUSCH) transmission.

13. The apparatus of claim 12, wherein the at least one rule dictates that:
when the first slot is configured as an SBFD slot, the one or more RACH preamble retransmissions are to be transmitted in an SBFD slot; and
when the first slot is configured as an HD slot, the one or more RACH preamble retransmissions are to be transmitted in an HD slot.

14. The apparatus of claim 13, wherein the at least one rule dictates that:
when the first slot is configured as an SBFD slot, the PUSCH transmission are to be transmitted in an SBFD slot; and
when the first slot is configured as an HD slot, the PUSCH transmission are to be transmitted in an HD slot.

15. The apparatus of claim 13, wherein the at least one rule dictates that:
the PUSCH transmission may be transmitted in an SBFD slot or an HD slot independent of whether the first slot is configured as an SBFD slot or an HD slot.

16. The apparatus of claim 12, wherein the at least one rule dictates that the one or more RACH preamble retransmissions may be transmitted in an SBFD slot or an HD slot independent of whether the first slot is configured as an SBFD slot or an HD slot.

17. The apparatus of claim 16, wherein the at least one rule dictates that:
when a most recent of the RACH preamble transmission and the one or more RACH preamble retransmissions is transmitted in an SBFD slot, the PUSCH transmission is to be transmitted in an SBFD slot; and
when a most recent of the RACH preamble transmission and the one or more RACH preamble retransmissions is transmitted in an HD slot, the PUSCH transmission is to be transmitted in an HD slot.

18. The apparatus of claim 16, wherein the at least one rule dictates that:
when a majority of the RACH preamble transmission and the one or more RACH preamble retransmissions are transmitted in SBFD slots, the PUSCH transmission is to be transmitted in an SBFD slot; and
when a majority of the RACH preamble transmission and the one or more RACH preamble retransmissions are transmitted in HD slots, the PUSCH transmission is to be transmitted in an HD slot.

19. The apparatus of claim 11, wherein the one or more processors are further configured to cause the apparatus to:
transmit signaling indicating a subset of the one or more slots to consider as available for use for the at least one subsequent transmission, wherein the signaling is transmitted after the network entity receives the RACH preamble.

20. A method for wireless communication at a user equipment (UE), comprising:
receiving configuration information indicating one or more slots including subband full duplex (SBFD) slots and half duplex (HD) slots;
transmitting, in a first slot, a random access channel (RACH) preamble associated with a RACH procedure;
determining, based on at least one rule, at least one second slot from the one or more slots to use for at least one subsequent transmission associated with the RACH procedure; and
transmitting the at least one subsequent transmission in the at least one second slot in accordance with the at least one rule.
